(19) United States
(12) Patent Application Publication
(10) Pub. No.: US 2025/0341451 A1
(43) Pub. Date: Nov. 6, 2025

(54) Thermostatic Assembly, in Particular for Laboratory Chambers, Climate Chambers, Cold Chambers or Environment Simulation Chambers

(71) Applicant: Binder GmbH, Tuttlingen (DE)

(72) Inventors: Christian HÖFER, Mühlhausen-Ehingen (DE); Hartmut WINKLER, Tuttlingen (DE); Jochen BUSCHLE, Tuttlingen (DE)

(73) Assignee: Binder GmbH, Tuttlingen (DE)

(21) Appl. No.: 19/197,207

(22) Filed: May 2, 2025

(30) Foreign Application Priority Data
May 3, 2024 (DE) 102024112545.4

(51) Int. Cl. G01N 1/42; F25B 9/10

(52) U.S. Cl. CPC G01N 1/42; F25B 9/10

(57) ABSTRACT

The application relates to a thermostatic assembly with a cooling circuit with a coolant, wherein the cooling circuit comprises a cold source, a consumer heat exchanger in the return of the cold source and a pump, wherein the cold source is part of a second heat exchanger across which an external refrigerant circuit (with a refrigerant is coupled to the cooling circuit, wherein the external refrigerant circuit comprises a compressor, a condenser and a first choke element.

### CROSS REFERENCE TO RELATED APPLICATIONS

The present application claims the benefit of priority to German Patent Application No. 10 2024 112 545.4, filed May 3, 2024, the entirety of each of which is incorporated herein by reference.

### FIELD OF APPLICATION

The application relates to a thermostatic assembly, in particular for laboratory chambers, climate chambers, cold chambers or environment simulation chambers.

### BACKGROUND

Deployment of a thermostatic assembly is known for the thermostatic control of the temperature of a sample compartment of laboratory chambers, climate chambers, cold chambers or environment simulation chambers in order to regulate or fine tune the temperature in the sample compartment in the desired manner.

DE 10 2004 040 737 A1 discloses an assembly for the regulation of a constant forerun or feedline temperature at fluid cooling and in heat pumps, wherein a storage circuit, comprising a storage fluid for the energy transport, is provided which is connected with a cooling/heating circuit and a consumer load each, wherein into the storage circuit a storage reservoir is integrated and wherein in the storage circuit into the connection to the cooling/heating circuit a buffer storage, through which a storage fluid can flow in one direction, and the consumer load, are connected in series and parallel to the buffer storage is provided a connection, whose throughflow is adjustable between an inlet line and an outlet line of the buffer storage. Such assembly enables maintaining the forerun at a constant temperature, and for regulating, if desired, the heating and cooling capacity can be limited at the consumer load. The buffer storage acts herein as energy storage and energy is extracted and stored as required. An off-time of a compressor can be bridged over without the forerun temperature increasing or decreasing. However, a buffer storage is complex and requires additional energy.

The application therefore addresses the problem of providing a thermostatic assembly with which a more effective thermostatic temperature control is enabled.

Advantageous embodiments and further developments of the application are specified in the dependent claims.

### SUMMARY

In the thermostatic assembly according to the invention with a cooling circuit with a coolant, wherein the cooling circuit comprises a cold source, a consumer heat exchanger in the return of the cold source, and a pump, wherein the cold source is part of a second heat exchanger across which an external refrigerant circuit with a refrigerant is coupled to the cooling circuit, the external refrigerant circuit comprises a compressor, a condenser and a first choke element. The compressor is a speed-controlled compressor. By disposing a compressor in combination with a choke element in the external refrigerant circuit reduction of the required energy is enabled since the provision of the required cold can take place depending on the situation. A cold reservoir or a buffer storage in which energy, in particular in the form of cooled coolant, must be held available can therewith be omitted.

The compressor is preferably disposed in the return of the second heat exchanger and the first choke element is disposed in the forerun of the second heat exchanger. Such disposition enables cooling.

The compressor is advantageously developed as an inverter compressor. This enables efficient energy saving.

According to an one embodiment, the first choke element is developed as an electro-magnetic valve, in particular as a solenoid-operated valve with a capillary tube or as a continuous valve. Solenoid-operated valves are especially robust, continuous valves can be driven well, preferably steplessly, and therefore enable especially fine dosing or metering.

One embodiment provides for a second choke element and an evaporator to be disposed parallel to the first choke element and the second heat exchanger. Such evaporator can enable dehumidification of the laboratory chamber, climate chamber, cold chamber or environmental simulation chamber; it can enable specific dehumidification in particular by means of the second choke element. The second choke element is in particular drivable independently of the first choke element.

The evaporator is preferably developed as a roll bond evaporator. Such evaporator can be produced simply and cost-effectively and be developed, in particular, such that it is space-saving.

The second choke element is preferably developed as a solenoid-operated valve, in particular as a solenoid-operated valve with a capillary tube, or as a continuous valve. Solenoid-operated valves are especially robust, continuous valves can be driven well, especially steplessly, and enable therefore especially fine dosing or metering.

Advantageously, across a third choke element, disposed in particular parallel to the first choke element and the second heat exchanger, re-injection of refrigerant into the compressor takes place. The re-injection can take place under control across the third choke element such that especially specifically the required quantity of refrigerant is returned whereby cooling of the compressor is enabled. The third choke element is drivable in particular independently of the first and, if available, of the second choke element.

The third choke element is preferably developed as a solenoid-operated valve, in particular as a solenoid-operated valve with a capillary tube or as a continuous valve. Solenoid-operated valves are especially robust, continuous valves can be driven well, preferably steplessly, and enable therefore especially fine dosing or metering.

The first choke element and/or the second choke element and/or the third choke element are preferably developed such that they are controllable.

According to one embodiment, the second heat exchanger is developed as a plate heat exchanger or coaxial tube heat exchanger. Such heat exchangers can be structured compactly and enable good heat transfer.

The cooling circuit preferably comprises as the coolant a non-combustible fluid, for example a water-glycol mixture, a silicone oil or a salt solution. Depending on the demands made at the sample compartment of the particular laboratory chamber, climate chamber, cold chamber or environment simulation chamber, the relevant safety requirements can thereby be met.

According to a development, the external refrigerant circuit comprises as the refrigerant a hydrocarbon, in particular propane or isobutane, or CO₂. Such refrigerants represent a climate-friendly alternative to halogenated refrigerants since they do not substantially contribute to the greenhouse effect, wherein, however, due to the combustibility of such refrigerants, increased safety requirements must be made of their use. Thereby that the cooling circuit and the external refrigerant circuit are separated from one another, there is the feasibility of utilizing combustible refrigerants in the external refrigerant circuit.

The pump of the cooling circuit is preferably developed as a circulation pump, in particular as a speed-controlled circulation pump. A speed-controlled pump can be operated especially energy-efficiently. The pump can be developed, for example, as a brine pump, glycol pump or water pump.

An embodiment provides for an overpressure valve, a venting valve and/or a diaphragm expansion vessel or a cooling circuit with gas overlay to be disposed in the cooling circuit. Through a diaphragm expansion vessel or a cooling circuit with gas overlay a volume expansion of the coolant can be taken into account, wherein no coolant needs to be drained. An overpressure valve as a safety valve can discharge coolant for the reduction of pressure when a maximum value of the pressure has been exceeded. Air or another gas can be discharged across a venting valve.

A laboratory chamber, climate chamber, cold chamber or environment simulation chamber with a sample compartment comprises a thermostatic assembly, wherein the consumer heat exchanger is disposed such that it thermostatically controls the temperature of the sample compartment. The advantages of such a laboratory chamber, climate chamber, cold chamber or environment simulation chamber correspond to those described in conjunction with the thermostatic assembly.

A further development provides for the external refrigerant circuit, preferably including the second heat exchanger, to be disposed in a machine compartment, separated from the sample compartment, which, in particular, comprises ventilation openings. In particular such separation between external refrigerant circuit and cooling circuit enables using a combustible refrigerant in the external refrigerant circuit since the external refrigerant circuit is disposed in a machine compartment, separated from the sample compartment, which can be well ventilated such that here the safety requirements made of the refrigerant circuits with combustible refrigerants can be met which is not feasible in a closed sample compartment in the presence of possible ignition sources. The energy input from the sample compartment into the consumer heat exchanger for cooling the sample compartment can take place by means of the cooling circuit, wherein the second heat exchanger is disposed in the machine compartment outside of the sample compartment.

In an advantageous further development the sample compartment is delimited by an inner wall which, at least in sections, is encased by an outer wall, wherein on an outer side of the outer wall an insulation is at least section-wise disposed and the insulation is encased by a housing, wherein the consumer heat exchanger is disposed between the inner wall and the outer wall. Such disposition enables an especially effective energy input from the sample compartment into the consumer heat exchanger.

An embodiment provides for the evaporator to be disposed between the outer wall and the insulation. Such disposition enables especially effective dehumidification of the sample compartment of the laboratory chamber, climate chamber, cold chamber or environment simulation chamber.

### BRIEF DESCRIPTION OF THE DRAWINGS

In the following the application will be explained in detail in conjunction with embodiment examples. Therein depict:

FIG. 1 a schematic representation of a first embodiment example of a thermostatic assembly with a cooling circuit with a cold source, a consumer heat exchanger and a pump as well as with an external refrigerant circuit with a compressor, a condenser and a first controllable choke element, wherein the cooling circuit and the external refrigerant circuit are coupled with one another across a second heat exchanger,

FIG. 2 a schematic representation of a second embodiment example of a thermostatic assembly which corresponds to the thermostatic assembly depicted in FIG. 1 and additionally comprises a third choke element for the re-injection into the compressor,

FIG. 3 a schematic representation of a third embodiment example of a thermostatic assembly which corresponds to the thermostatic assembly depicted in FIG. 2 and additionally comprises a second choke element and an evaporator parallel to the first choke element and the second heat exchanger,

FIG. 4 a schematic representation of a laboratory chamber, climate chamber, cold chamber or environment simulation chamber with a thermostatic assembly according to FIG. 1, and

FIG. 5 a schematic representation of the laboratory chamber, climate chamber, cold chamber or environment simulation chamber according to FIG. 4 which additionally comprises an evaporator for dehumidification.

### DETAILED DESCRIPTION

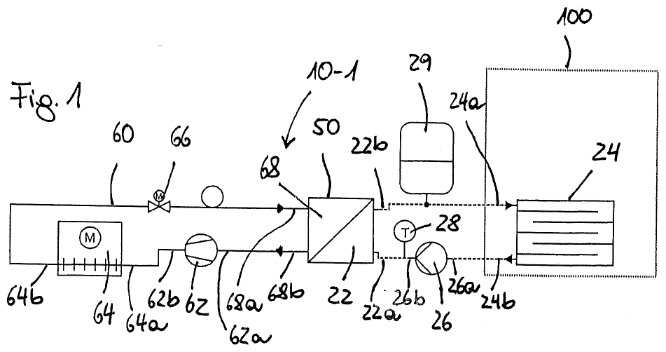

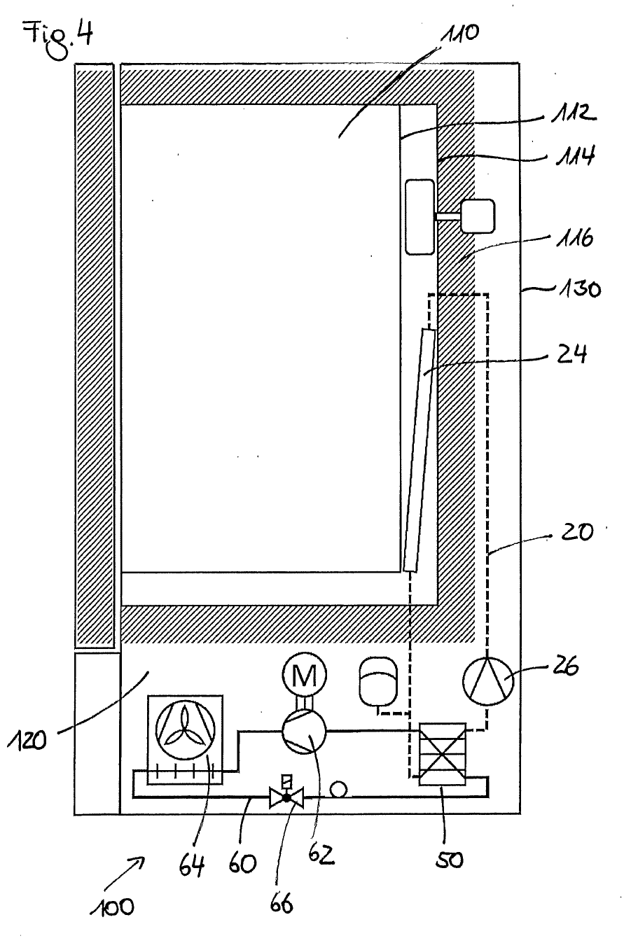

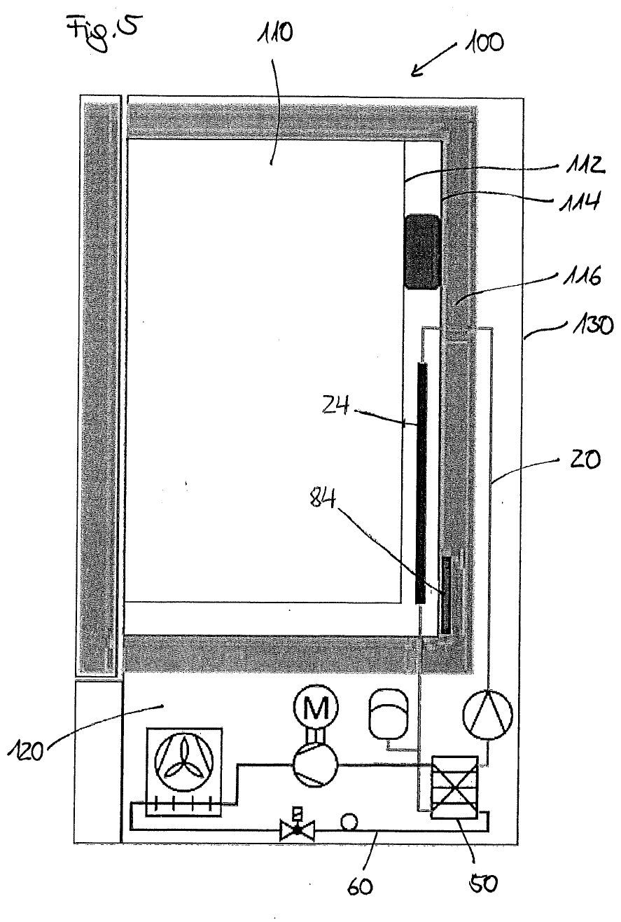

FIGS. 1 to 3 show different embodiment examples of thermostatic assemblies 10-1, 10-2 and 10-3. FIGS. 4 and 5 illustrate the installation of such thermostatic assemblies. Like reference numbers denote like or functionally like components, wherein, for clearer viewing, not all reference numbers are provided in all Figures.

FIG. 1 shows a schematic representation of a first embodiment example of a thermostatic assembly 10-1 with a cooling circuit 20, represented hatched for purposes of illustration, in which a coolant is disposed. The coolant is a fluid which can circulate through the cooling circuit. The coolant can be a non-combustible fluid, for example a water-glycol mixture, a silicone oil or a salt solution.

The cooling circuit 20 comprises a cold source 22 with a forerun 22a and a return 22b, a consumer heat exchanger 24 with a forerun 24a and a return 24b, which is disposed in the return 22a of the cold source 22, and a pump 26 in the return 24b of the consumer heat exchanger 24 and in the forerun 22a of the cold source 22. Alternatively, the pump 26 can also be disposed in the forerun 24a of the consumer heat exchanger 24. The pump 26 of the cooling circuit 20 can be developed as a circulation pump, in particular as a speed-controlled circulation pump. Driving takes place across a control unit not shown. The consumer heat exchanger 24 can be developed as a fin-type heat exchanger, plate heat exchanger or as a micro-channel heat exchanger. Depending on its physical form, the consumer heat exchanger 24 can be disposed obliquely with respect to the vertical (cf. FIG. 4) for example in the case of a fin-type heat exchanger or a micro-channel heat exchanger, or it can be disposed, for example in the case of a plate heat exchanger, parallel to the vertical (cf. FIG. 5).

In the cooling circuit 20, for example in the return 26b of the pump 26, a temperature sensor 28 can be disposed.

In the cooling circuit 20, furthermore, can be disposed an overpressure valve and or a venting valve. The cooling circuit 20 can, furthermore, comprise a diaphragm expansion vessel 29 or a cooling circuit with gas overlay.

The cold source 22 is part of a second heat exchanger 50 across which an external refrigerant circuit 60 is coupled to the cooling circuit 20. For purposes of illustration, the refrigerant circuit 60 is depicted with drawn-through lines in order to be better able to differentiate it from the cooling circuit 20. In the refrigerant circuit 60 is disposed a refrigerant. The refrigerant is a fluid which can circulate through the refrigerant circuit 60. The refrigerant circuit 60 and the cooling circuit e20 are herein separated with respect to fluid technology. Only across the second heat exchanger 50 can thermal energy be transferred from the coolant of the cooling circuit 20 to the refrigerant of the refrigerant circuit 60. The refrigerant can be a combustible fluid, for example a hydrocarbon, in particular propane or isobutane, or CO₂.

The external refrigerant circuit 60 comprises a compressor 62 with a forerun 62a and a return 62b, a condenser 64 with a forerun 64a and a return 64b as well as a first choke element 66. The refrigerant circuit 60 comprises furthermore a cold source 68 with a forerun 68a and a return 68b, which is part of the second heat exchanger 50 and onto which thermal energy can be transferred from the cold source 22 of the cooling circuit 20.

In the depicted embodiment example the heat exchanger 50 is developed as a counterflow heat exchanger. However, it is fundamentally also feasible to operate the heat exchanger 50 in co-flow. The second heat exchanger 50 can be developed as a plate heat exchanger or as a coaxial tube heat exchanger.

The compressor 62 is in particular disposed in the return of the second heat exchanger 50, in particular in the return 68b of the cold source 68 of the refrigerant circuit 60 and the first choke element 66 is disposed in the forerun of the second heat exchanger 50, in particular in the forerun 68a of the cold source 68 of the refrigerant circuit 60. The condenser 64 is disposed in the return 62b of the compressor 62 and in the forerun 66a of the first choke element 66.

The first choke element 66 can be developed in particular as a solenoid-operated valve with a capillary tube or as a continuous valve. The driving or control takes place across a not depicted driving or control device.

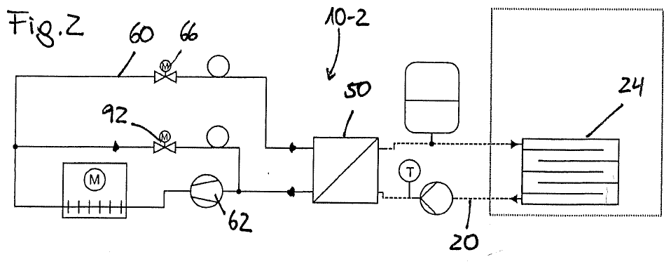

FIG. 2 shows a schematic representation of a second embodiment example of a thermostatic assembly 10-2 which differs from the first embodiment example of the thermostatic assembly 10-1 essentially thereby that a third choke element 92 can be provided by means of which a re-injection of refrigerant into the compressor 62 can take place. For this purpose, the third choke element 92 is in particular disposed parallel to the first choke element 66 and the second heat exchanger 50. Stated differently, in the present embodiment example a parallel line, in which the third choke element 92 is disposed, branches from the return of the condenser 64 of the refrigerant circuit 60 into the forerun 62a of the compressor 62.

The third choke element 92 can be developed as a solenoid-operated valve, in particular as a solenoid-operated valve with a capillary tube or as a continuous valve. Driving or control takes place across a not depicted driving or control device, wherein the driving or control can, in particular, take place independently of the driving or control of the first choke element 66.

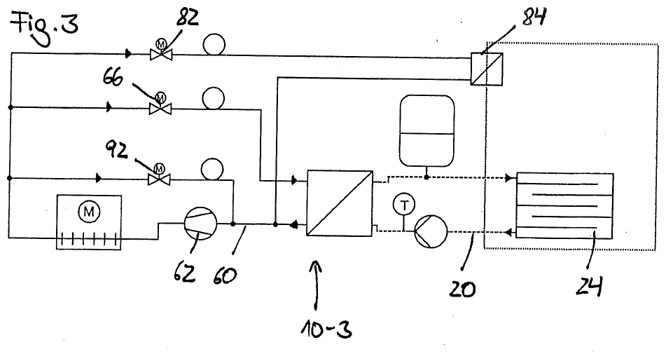

FIG. 3 shows a schematic representation of a third embodiment example of a thermostatic assembly 10-3 which differs from the second embodiment example of the thermostatic assembly 10-2 substantially thereby that additionally a second choke element 82 and an evaporator 84 can be disposed parallel to the first choke element 66 and the second heat exchanger 50. Stated differently, in the present embodiment example a parallel line, in which the second choke element 82 and the evaporator 84 are disposed, branches out from the return of the condenser 64 out of the refrigerant circuit 60 into the forerun 62a of the compressor 62. It should here be noted that the second choke element 82 and the evaporator 84 can, in principle, also be applied in the first embodiment example of the thermostatic assembly 10-1 and consequently is independent of the presence of the third choke element 92.

The second choke element 82 can be developed as a solenoid-operated valve, in particular as a solenoid-operated valve with a capillary tube or as a continuous valve. Driving or control takes place across a not depicted drive or control device, wherein, in particular, driving or control can take place independently of the drive or control of the first choke element 66 and, if present, independent of the drive or control of the third choke element 92.

The evaporator 84 can be developed as a roll bond evaporator.

FIG. 4 shows a schematic representation of a laboratory chamber, climate chamber, cold chamber or environment simulation chamber 100 with a sample compartment 110 and a thermostatic assembly 10-1 as described in conjunction with FIG. 1, wherein the consumer heat exchanger 24 is disposed such that it thermostatically controls the temperature of the sample compartment 110. In principle, the installation of all thermostatic assemblies 10-1 to 10-3 as described in conjunction with FIGS. 1 to 3 into the laboratory chamber, climate chamber, cold chamber or environment simulation chamber 100 is conceivable.

The laboratory chamber, climate chamber, cold chamber or environment simulation chamber 100 comprises a machine compartment 120, separated from the sample compartment 110, wherein the external refrigerant circuit 60, preferably including the second heat exchanger 50, is disposed in the machine compartment 120.

The machine compartment 120 comprises in particular ventilation openings and can thereby comply with the safety requirements made of the use of combustible refrigerants, in particular hydrocarbons such as propane or isobutane. Only the consumer heat exchanger 24 of the thermostatic assembly 10-1 is advantageously disposed in or on the sample compartment 110 while the further components of the thermostatic assembly 10-1 are spatially separately disposed in the machine compartment 120.

The sample compartment 110 can be delimited by an inner wall 112 which at least sectionally can be encased by an outer wall 114, wherein on an outer side of the outer wall 114 at least sectionally an insulation 116 can be disposed and the insulation 116 can be encased by a housing 130. The consumer heat exchanger 24 is advantageously disposed between the inner wall 112 and the outer wall 114 in order to be able to enable good temperature input from the sample compartment 110.

FIG. 5 shows the laboratory chamber, climate chamber, cold chamber or environment simulation chamber 100 according to FIG. 4, wherein in the thermostatic assembly 10-1 additionally the evaporator 84, as explained in conjunction with FIG. 3, is disposed. The evaporator 84 is herein disposed between the outer wall 114 and the insulation 116 in order to enable dehumidification.

### LIST OF REFERENCE NUMBERS

10-1 to 10-3 Thermostatic assembly
20 Cooling circuit
22 Cold source
22a Forerun
22b Return
24 Consumer
24a Forerun
24b Return
26 Pump
26a Forerun
26b Return
28 Temperature sensor
29 Diaphragm expansion vessel
50 Second heat exchanger
60 External refrigerant circuit
62 Compressor
62a Forerun
62b Return
64 Condenser
64a Forerun
64b Return
66 First choke element
68 Cold source
68a Forerun
68b Return
82 Second choke element
84 Evaporator
92 Third choke element
100 Laboratory chamber, climate chamber, cold chamber or environment simulation chamber
110 Sample compartment
112 Inner wall
114 Outer wall
116 Insulation
120 Machine compartment
130 Housing

1. A thermostatic assembly, comprising:
a cooling circuit with a coolant, wherein the cooling circuit comprises:
a cold source;
a cold source return;
a consumer heat exchanger in the cold source return;
a pump;
wherein the cold source is part of a second heat exchanger across which an external refrigerant circuit with a refrigerant is coupled to the cooling circuit; and
wherein the external refrigerant circuit comprises a compressor, a condenser and a first choke element.

2. The thermostatic assembly as in claim 1, wherein the compressor is disposed in a return of the second heat exchanger and the first choke element is disposed in a forerun of the second heat exchanger.

3. The thermostatic assembly as in claim 1, wherein the compressor is an inverter compressor.

4. The thermostatic assembly as in claim 1, wherein the first choke element is a solenoid-operated valve.

5. The thermostatic assembly as in claim 1, further comprising a second choke element and an evaporator disposed parallel to the first choke element and the second heat exchanger.

6. The thermostatic assembly as in claim 5, wherein the evaporator is a roll bond evaporator.

7. The thermostatic assembly as in claim 5, wherein the second choke element is a solenoid-operated valve.

8. The thermostatic assembly as in claim 1, further comprising a third choke element disposed parallel to the first choke element and the second heat exchanger, wherein re-injection of refrigerant into the compressor occurs across the third choke element.

9. The thermostatic assembly as in claim 8, wherein the third choke element is a solenoid-operated valve.

10. The thermostatic assembly as in claim 2, wherein the second heat exchanger is a plate heat exchanger or a coaxial tube heat exchanger.

11. The thermostatic assembly as in claim 1, wherein the cooling circuit comprises a non-combustible fluid as the coolant.

12. The thermostatic assembly as in claim 1, wherein the external refrigerant circuit comprises a hydrocarbon as the refrigerant.

13. The thermostatic assembly as in claim 1, wherein the pump of the cooling circuit is a circulation pump.

14. The thermostatic assembly as in claim 1, further comprising an overpressure valve disposed in the cooling circuit.

15. The thermostatic assembly as in claim 1, further comprising a venting valve disposed in the cooling circuit.

16. The thermostatic assembly as in claim 1, further comprising a diaphragm expansion vessel or a cooling circuit with gas overlay disposed in the cooling circuit.

17. A laboratory device, comprising:
a climate controlled chamber with a sample compartment;
thermostatic assembly, comprising:
a cooling circuit with a coolant, wherein the cooling circuit comprises:
a cold source;
a cold source return;
a consumer heat exchanger in the cold source return;
a pump;
wherein the cold source is part of a second heat exchanger across which an external refrigerant circuit with a refrigerant is coupled to the cooling circuit;
wherein the external refrigerant circuit comprises a compressor, a condenser and a first choke element; and
wherein the consumer heat exchanger is disposed such that it thermostatically controls the temperature in the sample compartment.

18. The laboratory device as in claim 17, further composing:
a machine compartment with ventilation openings, wherein the machine compartment is separated from the sample compartment;
wherein the external refrigerant circuit includes a second heat exchanger and the external refrigerant circuit is disposed in the machine compartment.

19. The laboratory device as in claim 18, wherein the sample compartment is delimited by an inner wall, which, at least sectionally, is encased by an outer wall, wherein on an outer side of the outer wall at least sectionally an insulation is disposed and the insulation is encased by a housing, wherein the consumer heat exchanger is disposed between the inner wall and the outer wall.

20. The laboratory device as in claim 18, wherein the evaporator is disposed between the outer wall and the insulation.
